(19) United States
(12) Patent Application Publication
(10) Pub. No.: US 2026/0015830 A1
(43) Pub. Date: Jan. 15, 2026

(54) MACHINE GUIDANCE SYSTEM AND METHOD FOR TRACKING CONSTRUCTION VEHICLES AND SURROUNDING TERRAIN

(71) Applicant: EQUIPMENTSHARE.COM INC, Columbia, MO (US)

(72) Inventors: James Dianics, San Diego, CA (US); Shane Trimble, Dublin (IE); Seth Kasmann, Columbia, MO (US); David Pasley, Topeka, KS (US); Rob Martin, Columbia, MO (US); Sheila Bagley, Columbia, MO (US)

(21) Appl. No.: 19/268,511

(22) Filed: Jul. 14, 2025

Related U.S. Application Data
(60) Provisional application No. 63/671,519, filed on Jul. 15, 2024.

(51) Int. Cl. E02F 9/24; E02F 9/26; G01S 17/89; G01S 17/931; G06V 10/26; G06V 10/80; G06V 20/58

(52) U.S. Cl. CPC E02F 9/24; E02F 9/261; E02F 9/264; G01S 17/89; G01S 17/931; G06V 10/26; G06V 10/803; G06V 20/58

(57) ABSTRACT

A machine guidance system and method uses a sensor suite and a processing unit to provide real-time tracking and terrain mapping for construction vehicles. Data comprising point cloud information generated by an optical sensor, geographic data provided by a location sensor, and motion data detecting acceleration, angular velocity, and/or orientation from a movement sensor are received. These data are fused by the processing unit to calculate the position and orientation of moveable parts, identify obstacles, and/or generate terrain maps. The system and method improve operational efficiency and safety in dynamic construction environments by enabling precise control of vehicle attachments, avoiding obstacles, and monitoring terrain.

### CROSS-REFERENCE TO RELATED APPLICATIONS

This application claims priority to U.S. Provisional Application No. 63/671,519 (filed 15 Jul. 2024). This application is related to U.S. patent application Ser. No. ______ (Attorney Docket No. EQS-003US2; 661-0116US2); Ser. No. ______ (Attorney Docket No. EQS-003US3; 661-0116US3); and Ser. No. ______ (Attorney Docket No. EQS-003US4; 661-0116US4) (filed concurrently with this application). The entire disclosures of these applications are incorporated herein by reference.

### TECHNICAL FIELD

The present disclosure is generally related to machine guidance systems for construction vehicles and, in particular, to systems and methods for tracking construction vehicles that have one or more than one attachment or other moveable part, as well as systems and methods for monitoring vehicle attachments and surrounding terrain to deliver real-time guidance and terrain mapping information.

### BACKGROUND

Construction vehicles play an important role in modern construction, where heavy machinery such as loaders, excavators, and dozers are routinely employed for earthmoving and material handling. Construction and related fields of work involve different tasks that are performed by different types of construction vehicles. Typical construction vehicles include loaders, excavators, compactors, and other earthmoving vehicles, any combination of which may be used at a work site. These vehicles incorporate various moveable components that are necessary for performing a range of tasks. For example, some construction vehicles have arms, appendages, attachments, or other moveable parts that can be manipulated during operation of the vehicle. For example, a loader includes a main body connected to a lift arm that can be raised and lowered, which in turn is connected to one of various attachments (such as a bucket attachment, a mower attachment, etc.).

In recent years, efforts have increased to integrate advanced sensing technologies and guidance systems into these machines. These systems are designed to improve operational efficiency and safety by providing real-time positional and orientation information to operators, which can support tasks such as attachment manipulation and grade control. The field of vehicle guidance continues to evolve as manufacturers and researchers seek to improve the integration of data from multiple sensors to offer more comprehensive support during machine operation.

A primary objective of guidance systems in this sector is to provide accurate, real-time information that facilitates precise control over machine movements and interactions with the surrounding environment. Modern construction operations demand tools that can help operators maintain desired work parameters, such as consistent grade and alignment, while also managing complex site conditions. Such systems work to combine data from various sensors to generate actionable feedback that improves productivity, reduces operator workload, and enhances jobsite safety.

Despite considerable progress, many conventional guidance solutions encounter significant challenges within harsh construction environments. Traditional systems often depend on wired components that are vulnerable to damage from vibration, dust, and adverse weather conditions. These vulnerabilities can lead to intermittent sensor failures and reduced measurement accuracy. In addition, systems that rely on disparate sensor data frequently struggle with issues related to calibration, synchronization, and data fusion, all of which can compromise the overall reliability of the positional information. As a result, operators may face inconsistent feedback about machine movements and environmental factors, hindering the ability to maintain precise control under dynamic worksite conditions.

Operators have also experienced difficulties in managing the complexities associated with rapidly changing construction environments and varied attachment configurations. Many guidance systems do not adequately address the need for simultaneous monitoring of vehicle dynamics and real-time terrain conditions. This shortcoming can result in limited situational awareness, where critical information regarding obstacles and uneven surfaces can be either delayed or inaccurate. Moreover, traditional approaches frequently require manual calibration or intervention when switching between different attachments or when environmental conditions change, which can lead to operational inefficiencies. These challenges highlight the importance of more robust, adaptable guidance solutions that can reliably integrate multiple data sources and provide precise control feedback, thereby supporting safer and more efficient construction operations.

Thus, there is a need for an improved machine guidance system that overcomes one or more of the drawbacks of conventional systems and/or that provides features not available in conventional systems.

### BRIEF SUMMARY OF THE DISCLOSURE

In one example, a machine guidance system for a construction vehicle includes a sensor suite mountable on the vehicle. The sensor suite comprises an optical sensor that can emit light pulses and receive reflected light. The optical sensor can generate point cloud data from a view that includes a movable part bearing a passive reflector. The system further includes a location sensor that obtains satellite signals to output location data representative of the vehicle's geographic position. The system additionally includes a movement sensor that generates data indicative of acceleration. The movement sensor can also generate data indicative of angular velocity, orientation, or related motion parameters. The system further includes a processing unit electrically coupled to the sensor suite. The processing unit can fuse the point cloud, location, and movement data to calculate the position and orientation of the movable part. The processing unit can identify obstacles located outside the vehicle. The processing unit can further generate a terrain map by segmenting the point cloud data into terrain features and distinguishing them from obstacles. The processing unit can control the vehicle by adjusting speed. The processing unit can also adjust the trajectory or can stop movement based on the calculated position and orientation, the identified obstacles, or the terrain map. In one example, the optical sensor is implemented as a light detection and ranging sensor. The light detection and ranging sensor can include a front sensor mounted toward the front of the vehicle. The sensor may also include a rear sensor mounted toward the rear. The front sensor and the rear sensor can further complement the point cloud data.

In another example, a method for machine guidance of a construction vehicle is provided. The method can include generating point cloud data using an optical sensor from a field of view that covers a movable part bearing a passive reflector. The method can include obtaining location data indicative of the vehicle's geographic position from satellite signals. The method can further include generating movement data indicative of at least one of acceleration, angular velocity, or orientation using a movement sensor. The generated sensor data can be fused to compute a position and orientation of the movable part. The fused data can also be used to identify an obstacle outside the vehicle. The fused data can further be utilized to generate a terrain map. The method can include modifying movement of the vehicle. The method can also include stopping movement of the vehicle or the movable part based on the computed position and orientation, the identified obstacle, or the terrain map. In one example, the point cloud data can be generated by both a front optical sensor and a rear optical sensor. The inclusion of both sensors can ensure enhanced coverage.

In an additional example, a machine guidance system incorporates distinct front and rear location sensors. The system can include one sensor providing a reference location. The system can also include a second sensor that outputs a location indicative of heading and pitch. The system further can include optical sensors, including front and rear light detection and ranging sensors, which can be employed in combination with an inertial measurement unit sensor. The inertial measurement unit sensor can indicate roll, pitch, or yaw. The system further includes a processing unit that can fuse the sensor data to calculate the position and orientation of the movable part. The processing unit can identify external obstacles. The processing unit can further generate a detailed terrain map. These and other features can enhance the precision of vehicle operation. These and other features can enhance the safety of vehicle operation.

These and various other embodiments of the machine guidance system are described in detail below, or will be apparent to one skilled in the art based on the disclosure provided herein, or may be learned from the practice of the disclosure provided herein. It should be understood that the above brief summary of the disclosure is not intended to identify key features or essential components of the invention, nor is it intended to be used as an aid in determining the scope of the claimed subject matter as set forth below.

### BRIEF DESCRIPTION OF THE DRAWINGS

A detailed description of various embodiments of a machine guidance system deployed on a construction vehicle is provided below with reference to the following drawings, in which:

FIG. 1 illustrates one example embodiment of a machine guidance system;

FIG. 2 illustrates one example of output devices shown in FIG. 1 operating in a standard mode;

FIG. 3 illustrates one example of output devices shown in FIG. 1 operating in a dual mode;

FIG. 4 illustrates one example of output devices shown in FIG. 1 operating in a quad mode;

FIG. 5 illustrates a flowchart of one example of a method for tracking a moveable part of an asset in relation to the surrounding terrain;

FIG. 6 is a perspective view of one example of the machine guidance system shown in FIG. 1 onboard an asset;

FIG. 7 is a top plan view of the machine guidance system and the asset shown in FIG. 6; and

FIG. 8 illustrates a perspective view of a machine guidance assembly.

### DETAILED DESCRIPTION OF EMBODIMENTS

The following detailed description provides various embodiments of a machine guidance system and method for tracking construction vehicles and their surrounding terrain. The described technology is directed toward improving the operation, guidance, and terrain mapping capabilities of construction vehicles, such as loaders, excavators, and other heavy machinery. By integrating advanced sensor technologies, data fusion techniques, and user interfaces, the described system enhances the precision, safety, and efficiency of construction operations.

While various examples of a machine guidance system deployed on a construction vehicle are described herein, not all embodiments of the inventive subject matter are limited to the specific configuration or methodologies of any of these embodiments unless explicitly recited or stated. Additionally, although the examples are described as embodying several different inventive features, any one of these features could be implemented without the others and that the inventive subject is not limited to any particular combination of features unless explicitly recited or stated.

The construction industry depends extensively on vehicles such as loaders, excavators, and dozers to carry out a variety of tasks, including earthmoving, grading, and material handling. These vehicles often incorporate moveable components, such as lift arms and attachments, which demand precise control and monitoring to maintain operational efficiency and safety. Traditional machine guidance systems, while providing some degree of assistance, face notable challenges. Many utilize wired components which can be susceptible to failure in demanding construction environments characterized by vibration, dust, and debris. Moreover, these systems frequently struggle to adapt seamlessly to different attachments, necessitating time-consuming recalibration or manual adjustments when switching between tools. Additionally, conventional systems generally emphasize providing positional data for the vehicle or its attachments but often overlook the surrounding terrain or obstacles, limiting operators' situational awareness and increasing the likelihood of errors or accidents. Examples of attachments include moveable parts, such as lift arms, bucket attachments, mower attachments, blades, soil conditioners, excavator buckets, or the like.

The described technology addresses these shortcomings by introducing an advanced machine guidance system that integrates multiple sensing technologies, data fusion algorithms, and real-time terrain mapping capabilities. A combination of optical sensors (e.g., LiDAR), location sensors (e.g., GNSS antennas and receivers), and movement sensors (e.g., inertial measurement units (IMUs)) is used to track the position and orientation of moveable parts of a construction vehicle with high precision. Unlike some known systems, the described technology eliminates the need for vulnerable wired components by utilizing passive reflectors on the vehicle's attachments, which reflect light pulses emitted by the optical sensors. This design enhances durability and simplifies the process of switching attachments, as the machine guidance system can be efficiently recalibrated by placing reflectors on new tools and performing reduced setup steps.

The system further distinguishes itself through the capability to generate real-time terrain maps and identify obstacles in the vehicle's environment. By fusing point cloud data from the optical sensors with location and movement data, the processing unit creates a comprehensive spatial model that incorporates both the vehicle's position and the surrounding terrain. Advanced filtering techniques, such as box filters and reflectivity-based thresholds, can be used to ensure that the system remains robust even in dusty or debris-filled environments. The terrain mapping functionality enables operators to visualize the vehicle's position in relation to the terrain and obstacles, enhancing situational awareness and supporting safer, more efficient operations. Additionally, the modular architecture of the system allows deployment across a wide range of construction vehicles, including loaders and excavators, and supports both manual and autonomous operation modes.

In summary, the inventive machine guidance system overcomes the limitations of traditional approaches by combining durable hardware configurations, advanced sensor fusion, and real-time environmental awareness. This integrated solution not only enhances the precision and reliability of vehicle guidance but also provides operators with actionable insights into their surroundings, enabling safer and more efficient construction workflows.

The subject matter described herein relates to machine guidance systems deployed on assets such as construction vehicles. In some examples, the machine guidance system is used to track one or more than one moveable part of the asset and generate guidance information to assist in operation of the asset. In some embodiments, the machine guidance system or method is also used to generate a map of an area of terrain surrounding the asset and generate terrain mapping information to enable display of the asset in relation to the surrounding terrain. A variety of different types of assets may be operated using the machine guidance system, such as loaders (for example, track loaders), excavators, compactors, backhoes, dozers, etc. Other types of assets that may be operated using the machine guidance system will be apparent to one of ordinary skill in the art.

The assets may be manually operated, autonomously operated, semi-autonomously operated, or may alternate between autonomous operation mode and manual operation mode. The guidance and/or terrain mapping information is provided to an operator of the asset via a human machine interface (HMI) as part of the guidance system. The guidance and/or terrain mapping information can be provided to a control system that is deployed within the asset or that is remote from the asset. This can allow for the asset to be remotely monitored and/or controlled from afar.

### I. Machine Guidance System

The machine guidance system disclosed herein may be deployed on a variety of different types of assets. The machine guidance system includes a processing unit configured to process sensor data provided by a sensor suite. The processing unit uses the processed sensor data to track the position of one or more than one moveable part of an asset. The processing unit can generate a map of an area of terrain surrounding the asset. The sensor suite may include one or more than one sensors, such as an optical sensor detecting and tracking one or more than one moveable parts of the asset. The sensor suite can include a position sensor such as a global navigation satellite system (GNSS) receiver (e.g., a global positioning system (GPS) navigation system) for determining the position of a GNSS antenna mounted on the asset. The sensor suite can include a movement sensor that determines acceleration (e.g., linear acceleration), angular velocity, and/or heading or orientation. One example of such as sensor is an inertial measurement unit (IMU) sensor for providing data relating to the rotation of the asset. The sensor suite can include a single sensor or multiple sensors. With respect to multiple sensors, the sensor suite can include at least one of each of two or more different sensors, or may include multiple sensors but less than all of the sensors described herein.

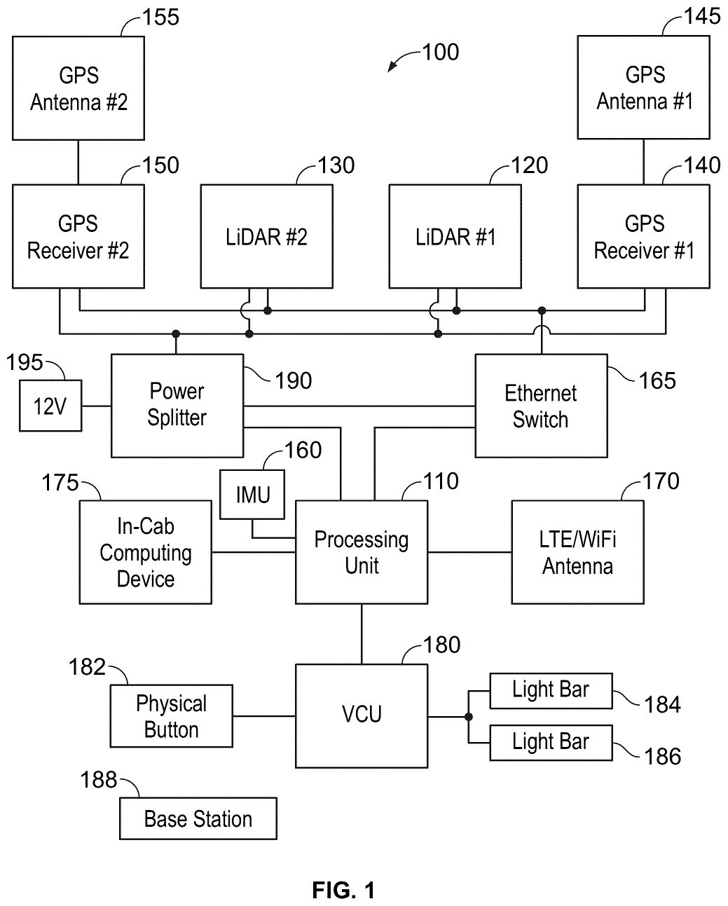

FIG. 1 illustrates one example embodiment of a machine guidance system 100. The machine guidance system 100 includes a processing unit 110. The processing unit 110 represents hardware circuitry that includes and/or is connected with one or more than one processors (e.g., integrated circuits, application-specific integrated circuits, field programmable gate arrays, graphics processing units, etc.) that perform the operations described in connection with the processing unit 110. If the processing unit 110 includes multiple processors, then the actions or operations performed by the processing unit 110 may be performed by each of the processors, or different processors may perform different actions or operations.

a. Optical Sensors

The machine guidance system 100 also includes one or more than one optical sensor 120, 130. The optical sensors 120, 130 track moveable parts, map terrain, and/or detect obstacles. These optical sensors 120, 130 can incudes LiDAR sensors, but in some embodiments can include stereo cameras, monocular cameras, time-of-flight (ToF) cameras, infrared (IR) sensors, radar sensors, or the like. The machine guidance system 100 includes one or more than one position sensors such as Global Navigation Satellite System (GNSS) receivers 140, 150 each respectively connected to a GNSS antenna 145, 155. The machine guidance system 100 includes a movement sensor 160, such as an inertial measurement unit (IMU) sensor. The movement sensor 160 may be included or onboard the processing unit 110, or may be separate from (but communicate with) the processing unit 110. The machine guidance system 100 in some embodiments includes a communication network device 165 that serves as a switch or connection between multiple computing devices. One example of such a network device 165 includes an Ethernet switch. The guidance system 100 can include a communication device 170 (e.g., a cellular or WiFi antenna), an onboard computing device 175, a vehicle control unit (VCU) 180 connected to an input device 182 and output devices 184, 186, and a power splitter 190 connected to a power adapter 195. The VCU 180 optionally can be referred to as an asset control unit (ACU) 180. The asset on which the machine guidance system 100 is deployed may be manufactured with these components, or one or more of these components may be later added to the asset (e.g., via upfitting). The output devices 184, 186 can be used to provide guidance information to the operator visually, audibly, tacitly and/or otherwise during operation of the asset. The aforementioned components may be separate components, or two or more (or all) of these components may be included in a single device.

The optical sensors 120, 130 are mounted at different location on the asset. In some embodiments, a single optical sensor 120 or 130 may be used, or more than two optical sensors 120, 130 may be used. One optical sensor 120 or 130 may be used to reduce the overall production cost of the machine guidance system 100, while three or more optical sensors 120, 130 may be used to provide redundancy. For example, a third or fourth (or more) optical sensor 120 and/or 130 may be included in the machine guidance system 100. If an optical sensor 120 or 130 fails, then the third or fourth (or other) optical sensor may be used in place of the failed optical sensor 120 or 130. As another example, data may be received from each of the three or more optical sensors 120, 130 and used for redundancy purposes. Two optical sensors 120, 130 are used in the illustrated example to provide a continuous 360 degree view around the asset (without the asset having to turn or rotate to provide the 360 degree view).

Each of the optical sensors 120, 130 can generate optical data representative of objects (or the absence of objects) within fields of view of the optical sensors 120, 130. With respect to LiDAR sensors, the optical sensors 120, 130 generate point cloud data based on light pulses emitted and reflected back from moveable parts of the asset. For example, the asset may include reflective surfaces or reflective objects (e.g., stickers, panels, etc.) may be affixed to the moveable parts of the asset. The moveable parts may be For example, if the construction vehicle is a loader, a reflector may be placed on the lift arm of the loader and a reflector may be placed on an attachment attached to the lift arm of the loader. The reflectors may be passive devices that reflect light back to the optical sensors 120, 130. For example, the reflectors may be retroreflectors that are not powered, and do not require power (electrical or otherwise), to operate. The reflectors may not be wired or otherwise conductively coupled with any power source. The reflectors may be tape, sheeting or other material with a reflective surface that is suitable for reflecting light back to a LiDAR sensor, such as the white aluminum foil tape. However, other optical sensors 120, 130 may be used, and other reflectors or no reflectors may be used.

The non-wired reflective surfaces (e.g., tape or plates) placed on moveable parts of the asset eliminates vulnerabilities or failure points associated with wired systems, such as damage from vibration, dust, or debris. This can help the machine guidance system 100 operate in harsh construction environments. In general, a harsh construction environment is a worksite characterized by challenging or extreme physical conditions that can impact the safety of workers, the durability of materials, and the overall progress and success of the project.

b. Asset Control Unit (ACU)

The ACU 180 or the processing unit 110 actively controls or limits the movement of the asset based on obstacle detection and terrain mapping to ensure safe and efficient operation. The ACU 180 represents the central processing and control module of the asset. The ACU 180 represents hardware circuitry that includes and/or is connected with one or more processors (e.g., one or more integrated circuits, application-specific integrated circuits, field programmable gate arrays, etc.) that perform the operations described herein in connection with the ACU 180. The processing unit 110 communicates with the ACU 180 of the asset. The asset control unit 180 is the central processing and control system integrated into the asset. The asset control unit 180 serves as the primary interface between the hardware components of the asset (e.g., sensors, actuators, and attachments) and the operator. The asset control unit 180 in some embodiments can autonomously or semi-autonomously control operation of the asset based on data and signals provided by the processing unit 110.

The ACU 180 receives input from the operator via the input device 182 and/or from the processing unit 110, with this input directing changes in movement of the asset, positions of arms of the asset, and/or positions/orientations of the attachment. For example, the ACU 180 can control cylinders, motors, engines, or the like, to move the asset, asset arms, and/or asset attachment based on input from the processing unit 110 and/or operator (e.g., through the input device 182).

Actuators, such as hydraulic cylinders, pneumatic cylinders, electric motors, or the like, onboard the asset are controlled by the processing unit 110 and/or ACU 180 adjust the tilt and/or position of the attachment to align the attachment (e.g., the cutting edge of a bucket) with the calculated slope and/or cross-slope parameters. The processing unit 110 and/or ACU 180 can modify the moving speed and trajectory of the asset to maintain consistent operation of the attachment along the slope and cross-slope.

Using real-time data from the optical sensors 120, 130, location sensors, and/or the movement sensor 160, the processing unit 110 identifies obstacles and differentiates the obstacles from terrain features while the asset is moving and/or stationary. If an obstacle is detected within the planned path of movement of the asset or within a threshold distance of the asset, the processing unit 110 or the ACU 180 can calculate an alternative route or stop the movement to prevent collisions and/or generate an alert to warn the operator (e.g., using sound generated via a speaker, flashes on the output devices 184, 186, or the like). Similarly, the terrain mapping data is analyzed to identify hazardous conditions, such as steep slopes, uneven surfaces, or unstable ground. The ACU 180 or processing unit 110 uses this information to dynamically adjust the speed, direction, and attachment positions of the asset. For example, the ACU 180 may limit the speed of the asset when approaching a steep incline or prevent the bucket or blade attachment from moving beyond a safe range of motion when operating near an obstacle. By integrating obstacle detection and terrain mapping with the ACU 180 or processing unit 110, the ACU 180 or processing unit 110 ensures that the asset operates within safe parameters, reducing the risk of accidents and improving overall operational efficiency.

c. Location Sensors

The location sensors (e.g., the GNSS antennas 145, 155 and associated receivers 140, 150) can be mounted at different locations on the asset. Each of the GNSS antennas 145, 155 receives and, in some embodiments, amplifies signals transmitted or broadcast by GNSS satellites and converts the signals for use by the GNSS receivers 140, 150. The GNSS receivers 140, 150 analyze the received signals to determine the positions of the GNSS antennas 145, 155. In one example, one GNSS antenna 145 serves as a system reference point for the machine guidance system 100, and another GNSS antenna 155 is used to determine heading and/or pitch of the asset. The GNSS receivers 140, 150 use real-time kinematics (RTK) positioning technology to provide more precise position information in one example.

The machine guidance system 100 may include two GNSS antennas 145, 155 mounted on the asset or may include more than two GNSS antennas 145, 155. The GNSS antennas 145, 155 and GNSS receivers 140, 150 work together to provide precise positional, heading, and pitch information for the asset. The GNSS antennas 145, 155 can be placed on the asset to serve distinct but complementary purposes. One GNSS antenna 145 can be placed closer to a front or leading edge of the asset and operate as the primary reference point for the machine guidance system 100. The signals received by this front GNSS antenna 145 are examined by the GNSS receiver 140 to provides the absolute position of the asset (e.g., in a global coordinate system, such as latitude, longitude, and altitude. This GNSS antenna 145 serves as the fixed reference for calculating heading and pitch when combined with data from the rear GNSS antenna 155. The front GNSS antenna 145 can be mounted on a stable, fixed part of the asset, typically near the front or center of the body of the asset.

The other GNSS antenna 155 can be mounted on the asset farther from the front than the front GNSS antenna 145 (and closer to the opposite back of the asset than the front GNSS antenna 145). The rear GNSS antenna 155 can be mounted on a moveable or rear part of the asset, such as the rear linkage or a stable rear section of the asset. The rear GNSS antenna 155 works with the front GNSS antenna 145 to calculate heading and pitch of the asset. The rear GNSS antenna 155 measures the relative position of the rear of the asset compared to the front. The rear GNSS antenna 155 provides signals to the GNSS receiver 150, which uses the signals to calculate the heading (e.g., the direction of travel) of the asset by calculating the angle between the two GNSS antennas 145, 155. The GNSS receiver 150 also can calculate the pitch of the asset (e.g., the tilt of the asset along its longitudinal axis) by comparing the vertical displacement between the two GNSS antennas 145, 155.

In some embodiments, the machine guidance system 100 does not include the GNSS receivers 140, 150 and/or antennas 145, 155. In these embodiments, the machine guidance system 100 uses other techniques to determine the real-world geographic position of the asset. For example, the machine guidance system 100 can include one or more than one reflector positioned at a known location. The optical sensor 120 and/or the optical sensor 130 generate point cloud data based on the light pulses emitted and reflected back from that reflector to determine the position of the optical sensor 120 and/or the optical sensor 130 and, therefore, the location of the asset relative to the reflector. Because the reflector location is known, the location of the asset relative to the reflector can then be converted into the location of the asset.

d. Movement Sensor

The movement sensor 160 is mounted on the asset and provides data relating to movement of the asset, such as rotation of the asset. This data can be repeatedly provided by the movement sensor 160 (e.g., to the processing unit 110), such as in a continuous stream or otherwise repeated stream of data. The movement sensor 160 can output signals indicative of roll, pitch, and/or yaw rotation of the asset. The movement sensor 160 can be mounted at or close to the center of rotation of the asset, or in another location.

e. Output Devices

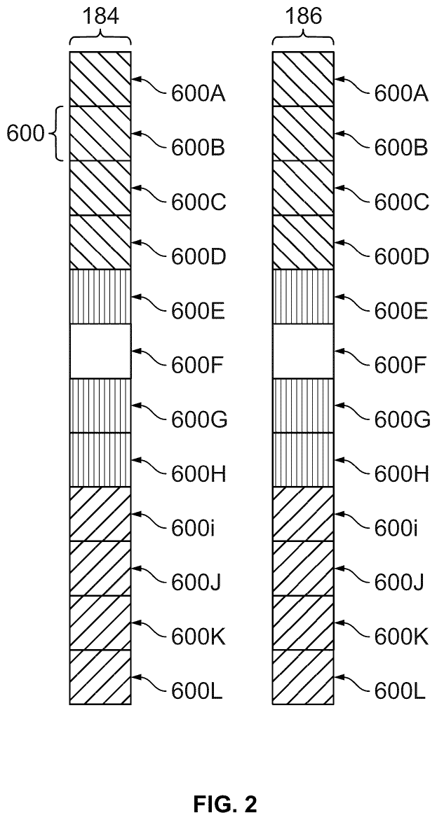

FIGS. 2 through 4 illustrate operation of one example of the output devices 184, 186 in different operating modes. As shown in this example, the output devices 184, 186 may include elongated lamps, such as elongated light emitting diode (LED) light bars that can be located to the left side and right side of the front end of the cab in the asset.

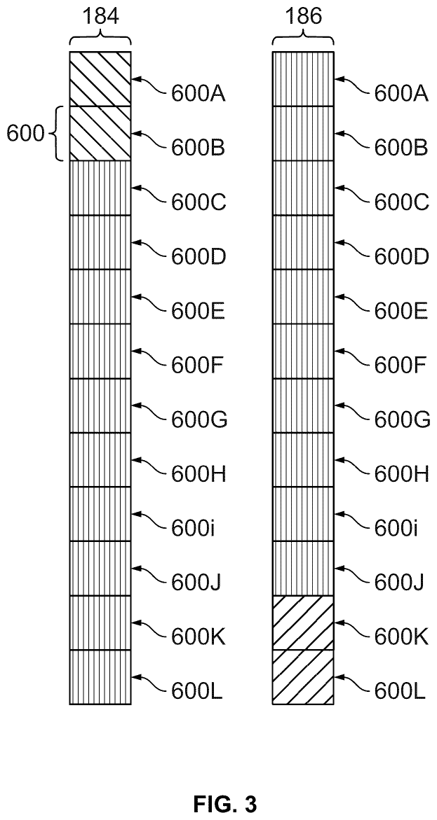

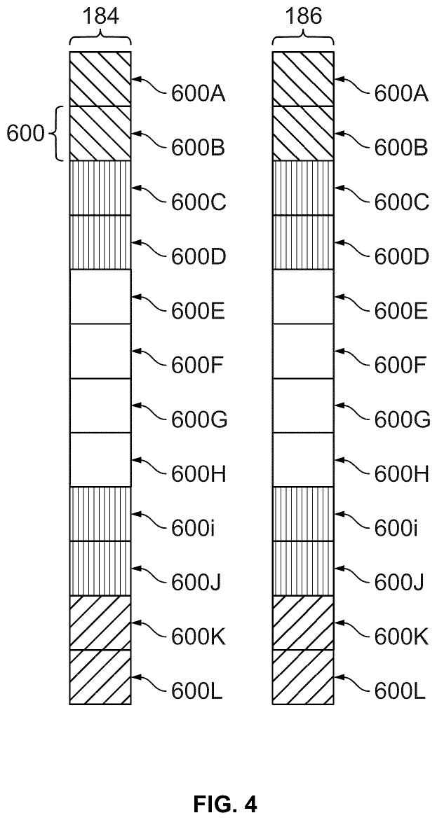

The output devices 184, 186 may operate in different modes, such as a standard mode (shown in FIG. 2), a dual mode (shown in FIG. 3), or a quad mode (shown in FIG. 4). The mode for the output devices 184, 186 can be selected by the operator using an input device 182 onboard the asset or the onboard computing device 175.

In each of these modes, the output devices 184, 186 illuminate different portions of each output device 184, 186 (e.g., along the length of the output devices 184, 186) to visually communicate elevations and/or positions (relative or absolute elevations and/or positions) of the asset and/or asset attachments to the operator of the asset. The processing unit 110 controls the output devices 184, 186 by calculating or otherwise determining the elevations and/or positions, and sending signals to the output devices 184, 186 to control which portions of the output devices 184, 186 are illuminated, as well as how the portions of the output devices 184, 186 are illuminated (e.g., using different colors, different light intensities, alternating between solid illumination versus flashing illumination, or the like). In another example, the output devices 184, 186 can be speakers that generate different sounds (e.g., different pitches, constant versus periodic sounds, etc.) to indicate the elevations and/or positions, and/or to indicate the proximity of an obstacle. In another example, the output devices 184, 186 can be haptic devices that generate different tactile responses to indicate the different elevations and/or positions. These haptic devices can be embedded in joysticks, steering wheels, or the like, of the asset, in the operator seat in the asset, in headphones or earphones worn by the operator, or the like.

Each output device 184, 186 can include different portions 600, with different portions 600 illuminated to indicate different edge elevations. The different portions 600 (e.g., portions 600A-L) can represent different LEDs disposed along the lengths of the output devices 184, 186, or different groups of LEDs disposed along the lengths of the output devices 184, 186. Different portions 600 can be illuminated in the same color, or in different colors, to visually communicate the edge elevations. The different portions 600 on the output devices 184, 186 may be the same shape or size, or may differ in appearance and/or size. While twelve portions 600 are illustrated in FIGS. 2 through 4, a greater number of portions 600 (e.g., thirteen portions, fourteen portions, fifteen portions, sixteen portions, and so on) or a lesser normal of portions 600 (e.g., eleven portions, ten portions, nine portions, eight portions, and so on) may be used.

For example, all portions 600 of each output device 184, 186 are illuminated, with one portion 600 illuminated in a different color or in another appearance (e.g., flashing versus constant light) to indicate the relative location of the represented part (e.g., the attachment edge, the end of the attachment edge, the center of the attachment edge, the track or wheels of the asset, etc.). For example, one portion 600 in each output device 184, 186 can be illuminated in a white color to indicate the location of the represented part, while other portions 600 in each output device 184, 186 remain illuminated in one or more than one other colors or appearances to indicate locations or areas above or below grade.

In one example of operation of the output devices 184, 186 in a standard mode shown in FIG. 2, the left edge elevation of the attachment is depicted on the left output device 184 and the right edge elevation of the attachment is depicted on the right output device 186. On each output device 184, 186, different visual outputs indicate different elevations of the respective attachment edges. One portion 600 in each output device 184, 186 can be illuminated in one color (e.g., white) to represent the current elevation of the respective attachment edge, while the other portions 600 in each output device 184, 186 remain illuminated in other colors (e.g., red, blue, green, etc.) to indicate other elevations that are at (or within a defined tolerance), above, or below grade. Each portion 600 can represent a unit above or below grade, such as one tenth of an inch, one millimeter, or the like.

For example, the portions 600A-D can be illuminated red to convey elevations above grade, the portions 600i-L can be illuminated blue to convey elevations below grade, and the portions 600E-H can be illuminated green to convey elevations at or within a defined tolerance of grade. The portion 600F in each of the output devices 184, 186 is illuminated white to indicate that the left and right edges of the bucket cutting edge are at or within tolerance of grade. If the asset or attachment is moved such that the left end of this edge is moved above grade, then at least one of the portions 600A-E in the output device 184 can be illuminated white (depending on how far the left end of the bucket edge is above grade), while the portions 600E-H are illuminated green (and the other portions 600A-E are illuminated red and the portions 600i-L are illuminated blue). When operating on cross-slopes, the output devices 184, 186 may have different portions 600 illuminated white. For example, the output device 184 can have the portion 600G illuminated white and the output device 186 can have the portion 600D illuminated to indicate that the left end of the bucket edge is at grade while the right end of the bucket edge is above grade. The portions 600 that are illuminated (e.g., illuminated white or another color) to indicate the elevation of the ends of the attachment can change as the attachment and/or asset moves (e.g., in real time).

In another example, the output devices 184, 186 can operate in a dual mode shown in FIG. 3. In this dual mode, the track elevation (e.g., the elevation of the bottom of the asset on the terrain surface) is depicted on the output device 184 and the center edge elevation of the attachment (e.g., the bucket) is depicted on the output device 186. In the output device 184, red light displayed in the portions 600A, 600B can indicate elevations of the track above grade, while green light displayed in the portions 600C-L can indicate elevations at grade. At least one of the portions 600 in the output device 184 can be illuminated white or another color to indicate the track elevation relative to above or at grade. The output devices 184, 186 can display multiple colors, such as red or green to indicate out of scope and within scope (e.g., the bucket edge is outside of a grading tolerance or within the grading tolerance, the tilt of the asset is outside of or within a tolerance, etc.), as well as white or blue to indicate the relative location of the bucket to grade, the relative tilt of the asset to a designated tilt or grade, etc. As another example, one or more other colors can be used. The portions 600 that are illuminated (e.g., illuminated white or another color) to indicate the track elevation and the elevation of the center of the edge of the attachment can change as the attachment and/or asset moves (e.g., in real time).

In another example, the output devices 184, 186 can operate in a quad mode shown in FIG. 4. In this quad mode, the elevation of the left edge of the attachment (e.g., the elevation of the left edge of the bucket) is depicted on the output device 184 and the tilt position of the asset is depicted on the output device 186. In each output device 184, 186, the portions 600A, 600B display a red light to indicate elevations above grade, the portions 600B, 600C, 600i, 600J display a green light to indicate elevations at grade (or within the defined tolerance of grade), and the portions 600K, 600L display a blue light to indicate elevations below grade. The portions 600E-H may not illuminate any light or may illuminate light of another color. The portions 600A-L showing the actual elevation of the left edge of the attachment and the tilt of the asset may be illuminated white (or another color), as described above.

In one example, one or more portions 600 of the output devices 184, 186 may be shaped, or include one or more than one gobo. A gobo is a stencil, template, or cutout placed in front of the portion(s) 600 to control the shape of the light emanating from the portion(s) 600. The gobo blocks parts of the light, projecting only the open or cut-out area. The gobo may have a shape to communicate information to the operator, such as the shape of an arrow. The gobo can be oriented to more clearly indicate to the operator when the illuminated portion 600 indicates a position above grade (e.g., an arrow pointing up) or below grade (e.g., an arrow pointing down).

f. Processing Unit

The processing unit 110 receives sensor data from the sensors of the machine guidance system 100 via the network device 165. The network device 165 (e.g., an Ethernet switch) manages the flow of sensor data from the optical sensors 120, 130, the movement sensor 160, and/or the location sensors (e.g., the receivers 140, 150) to the processing unit 110. The network device 165 may be a ruggedized gigabit Ethernet switch, although other components capable of performing packet switching (e.g., in accordance with the Ethernet or Industrial Ethernet (IE) standard) may be used.

### 1. Data Fusion

The processing unit 110 fuses or otherwise combines the sensor data received from the sensors in the sensor suite (e.g., the optical sensors 120, 130, the GNSS antennas 145, 155, the GNSS receivers 140, 150, and/or the movement sensor 160). The processing unit 110 uses the fused data to track moveable parts of the asset in relation to the surrounding terrain. The processing unit 110 uses the fused data to provide guidance and/or terrain mapping information to an operator of the asset.

The GNSS receivers 140, 150 provide real-time positional data for the asset. This allows for the processing unit 110 to precisely track the location of the asset at a worksite. This is useful for tasks such as mapping the terrain, defining work boundaries, and ensuring accurate excavation or grading. The heading of the asset can be used by the processing unit 110 to maintain alignment of the asset during operations such as trenching, grading, or material placement. The pitch of the asset can be used by the processing unit 110 to maintain proper blade or bucket angles, and ensure accurate grade control. The GNSS data can be fused with data from other sensors, such as the optical sensors 120, 130 and/or the movement sensor 160, to comprehensively track the position, orientation, and movement of the asset. This fusion improves the accuracy and reliability of the machine guidance system 100, especially during operation on dynamic or uneven terrain.

Using multiple GNSS antennas 145, 155 can provide more precise heading and pitch calculations compared to a single GNSS device. The combination of absolute positioning (e.g., using the front GNSS antenna 145) and relative positioning (e.g., using the rear GNSS antenna 155) allows for terrain mapping, grade control, obstacle avoidance, and the like.

Using the data output by dual or multiple GNSS antennas 145, 155 (e.g., front and rear antennas) in combination with the data output by the optical sensors 120, 130 can provide more precise positional, heading, and pitch information for the asset when compared with other machine guidance systems. For example, a dual location sensor configuration enables real-time tracking of the orientation and movement of the asset, which can be helpful for tasks such as grade control and terrain mapping. The dual location sensor setup provides increased accuracy for heading and pitch calculations compared to machine guidance systems that rely on single location sensors, while the integration with the optical sensors 120, 130 improves terrain mapping and obstacle detection.

2. Communication with Computing Devices

The processing unit 110 interfaces with the communication device 170 for communication with an off-board computing device over one or more than one computerized communication networks (e.g., a cellular network, a WiFi network, etc. This computing device can be a mobile phone, tablet computer, laptop computer, or the like, which may be used by an operator to input set-up information. The set-up information may include the type of asset and attachment to be operated with the assistance of the machine guidance system 100 and, in some embodiments, may also include one or more than one operating parameters to be used by the machine guidance system 100.

The processing unit 110 communicates with the onboard computing device 175 that can be located within the cab of the asset or on the roof of the asset. The onboard computing device 175 can be a mobile phone, a tablet computer, a laptop computer, or the like. The onboard computing device 175 may display various guidance information and maps that can be viewed by the operator during operation of the asset.

g. Input Devices and Output Devices

The processing unit 110 communicates with the asset control unit 180 of the asset. The asset control unit 180 is the central processing and control system integrated into the asset. The asset control unit 180 serves as the primary interface between the hardware components of the asset (e.g., sensors, actuators, and attachments) and the operator. The asset control unit 180 can, in some embodiments, autonomously and/or semi-autonomously control operation of the asset based on data and signals provided by the processing unit 110.

The asset control unit 180 controls actuators that adjust the position and movement of asset components, such as the position of a bucket or blade of the asset to provide proper alignment and grade control, the movement of arms of the asset, hydraulic pressures of the asset for control of the arms and attachments, and the like. The asset control unit 180 provides an operator interface and can output visual and/or audio feedback to the operator via displays, light bars, etc.

The asset control unit 180 interfaces with one or more than one input device 182 and one or more than one output device 184, 186, which may be located within the cab of the asset. The input device 182 may be a button, switch, lever, selectable icon on a graphical user interface, etc. The input device 182 can be used by the operator to input information during the set-up process. In another example, the operator may input this information using the onboard computing device 175. The output devices 184, 186 visually convey positional feedback information to the operator. For example, the output devices 184, 186 may be elongated displays or lamps (e.g., light bars) that illuminate to communicate positions of the asset, portions of the asset (e.g., arms of the skid steer loader), and/or attachments (e.g., a bucket connected to the arms). The output devices 184, 186 are elongated LED light bars used to provide guidance information to the operator during operation of the asset, as described above. During the set-up process, the output devices 184, 186 may be configured to operate in different modes, such as a standard mode, a dual mode, or a quad mode, as described herein. The onboard computing device 175 also can be an input and/or output device of the machine guidance system 100.

h. Base Station

The machine guidance system 100 also includes a base station 188. The base station 188 can be located off-board the asset, and may be a stationary component of the machine guidance system 100. For example, the base station 188 can be still while the asset moves at a worksite. The base station 188 may be moveable between different worksites (e.g., upon completion of work or usage of the machine guidance system 100 at one worksite, the base station 188 can be moved to another worksite).

The base station 188 can provide a fixed, high-accuracy reference point for the machine guidance system 100, such as for the GNSS antennas 145, 155 and/or GNSS receivers 140, 150. The base station 188 can include (and/or the base station 188 shown in FIG. 1 can represent) one or more GNSS antennas (e.g., similar or identical to the antenna 145 and/or 155) and/or one or more GNSS receivers (e.g., similar or identical to the receiver 140 and/or 150). The base station 188 may include or be connected to a power supply, such as a generator, power utility grid, battery or battery cells, etc. The base station 188 can include one or more than one communication device for wirelessly communicating with the processing unit 110 of the machine guidance system 100 (e.g., via the communication device 170). The communication device of the base station 188 may be similar or identical to the communication device 170. The base station 188 can include a processing unit similar or identical to the processing unit 110 of the machine guidance system 100.

The GNSS antenna of the base station 188 receives GNSS satellite signals that are used by the GNSS receiver of the base station 188 to calculate a geographic location (e.g., longitude, latitude, and/or altitude) of the base station 188. The processing unit of the base station 188 may communicate with the processing unit 110 of the machine guidance system 100, compare locations determined by the GNSS receivers 140 and/or 150 of the machine guidance system 100 and determined by the GNSS receiver of the base station 188, and decide whether the machine guidance system 100 is within a threshold distance limit from the base station 188. For example, the processing unit 110 of the machine guidance system 100 may not permit autonomous or semi-autonomous operation of the asset, terrain mapping or updating of terrain maps, etc. if the machine guidance system 100 (and, therefore, the asset) are more than five miles from each other (as one example, although other distances may be used).

The processing unit of the base station 188 can receive a designated location (e.g., longitude, latitude, and/or altitude) from an operator of the machine guidance system 100 or from another source (e.g., output from a survey of a worksite). The processing unit of the base station 188 compares this input location and compare the input location with the location calculated using the GNSS satellite signals received by the GNSS antenna of the base station 188. The processing unit of the base station 188 can calculate a difference, or error, between these locations. A correction can be calculated based on this difference, such as values to add or subtract to the longitude, latitude, and/or altitude values calculated by the GNSS receiver of the base station 188. This correction can be communicated from the base station 188 to the processing unit 110 of the machine guidance system 100. The processing unit 110 can then apply the correction to locations calculated by the GNSS receiver(s) 140, 150 of the machine guidance system 100 to ensure that any errors in the locations determined from the GNSS satellite signals are corrected.

In another example, the base station 188 may be mobile. For example, the base station 188 may include or be on wheels, tracks, or the like, for self-propelling or being moved (manually or with the aid of the asset or another vehicle). In another example, the base station 188 may be part of or coupled to a stationary object, such as a building or another structure. As another example, one of the GNSS antennas 145, 155 can receive signals for establishing the reference location described above.

### II. Tracking Process

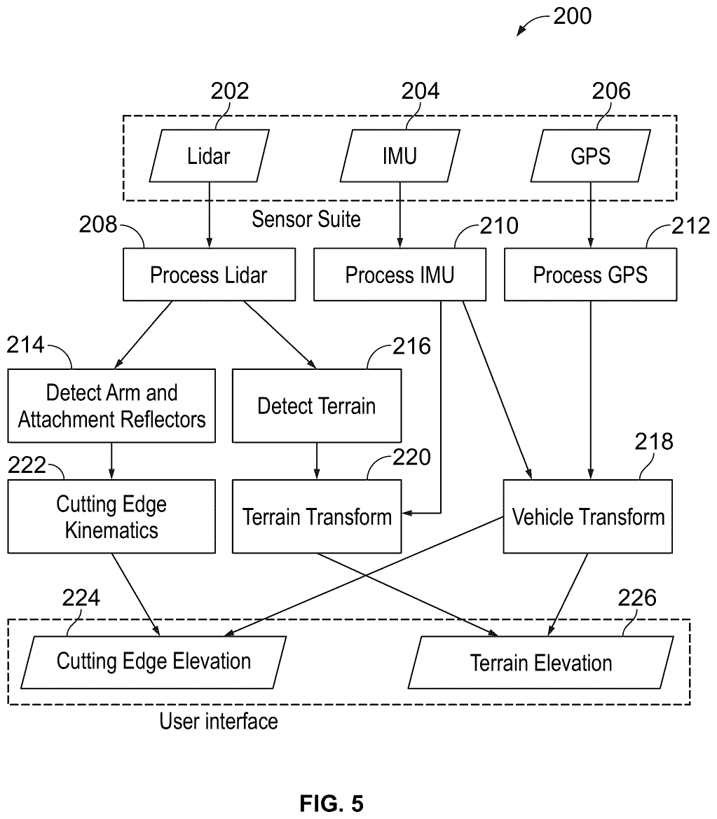

FIG. 5 illustrates a flowchart of one example of a method 200 for tracking a moveable part of an asset in relation to the surrounding terrain. While the operations of the method 200 are generally described with respect to FIG. 1, the operations may otherwise be performed. The method 200 can be used to track the cutting edge of a bucket attachment of a loader during the performance of grading (e.g., the process of shaping and leveling the ground before building). The method 200 can be used to position the cutting edge of the bucket attachment at a desired elevation relative to the elevation of the terrain. In some embodiments, the method 200 may be used in connection with other assets and/or attachments to perform different tasks.

The method 200 includes parallel processing operations—for example, the sensor data collection operations 202, 204, and/or 206 can be performed in parallel or during overlapping time periods, the sensor data processing operations 208, 210, and/or 212 can be performed in parallel or during overlapping time periods, the arm/attachment reflector and terrain detection operations 214 and 216 can be performed in parallel or during overlapping time periods, the terrain and vehicle transform and cutting edge kinematics operations 222, 220, and/or 218 can be performed in parallel or during overlapping time periods, the operations 224 and 226 relating to the display of cutting edge and terrain elevations via a user interface (e.g., the onboard computing device 175 and/or light bars 184, 186) can be performed in parallel or during overlapping time periods.

a. Data Collection and Fusion

At 202, optical data related to reflectors on the asset are collected. For example, the optical sensors 120, 130 can generate point cloud data based on light pulses emitted and reflected back from a reflector placed on a lift arm of the asset and/or another reflector placed on the attachment connected to the lift arm (e.g., the bucket attached to the lift arm). At 204, movement data representative of movement of the asset is generated. For example, the movement sensor 160 can generate movement data indicative of movement of the asset. This data can include roll, pitch, and/or yaw rotation parameters for the asset. At 206, location data is obtained and used to determine positions. For example, the GNSS receivers 140, 150 can analyze electrical signals received from the GNSS antennas 145, 155, respectively, to determine the positions of the GNSS antennas 145, 155. In some embodiments, the location sensors use RTK positioning technology to provide more precise position information about the asset (such as accuracy of about one centimeter).

At 208, 210, and 212, data is fused and processed. For example, the processing unit 110 can process the point cloud data provided by the optical sensors 120, 130 (at 208), process the movement data provided by the movement sensor 160 (at 210), and process the position data provided by the GNSS receivers 140, 150 (at 212). In some embodiments, less than all of this data is processed. The data can be processed by receiving and fusing the different sensor data based on the timestamps associated with the sensor data. For example, point cloud data, IMU data, and GNSS data may be fused (e.g., combined or associated with each other) if the respective timestamps are within a specified tolerance of each other. As another example, one or more Kalman filters or complimentary filters can be used to fuse the data. If one of the sensors 120, 130, 160, GNSS antennas 145, 155, and/or GNSS receivers 140, 150 fails or generates data that is outside of an acceptable range of values, the processing unit 110 can fuse the data from the remaining sensors 120, 130, 160, GNSS antennas 145, 155, and/or GNSS receivers 140, 150 by replacing the data from the failed sensors 120, 130, 160, GNSS antennas 145, 155, and/or GNSS receivers 140, 150 with data from another one of the sensors 120, 130, 160, GNSS antennas 145, 155, and/or GNSS receivers 140, 150 that has not failed. For example, if a GNSS antenna 145, 155 or GNSS receiver 140, 150 fails, the processing unit 110 can use data from the movement sensor 160 to replace the movement, velocity, pitch, etc. data that otherwise may have been obtained by the failed GNSS antenna 145, 155 and/or GNSS receiver 140 and/or 150.

b. Reflector Position Calculations

At 214, the position of one or more than one reflector on part of the asset is or are determined. For example, the processing unit 110 can analyze the optical data (from 208) to detect the position of a first reflector placed on part of the arm of the asset and the position of a second reflector placed on the attachment that is connected with (and separately moveable from) the arm. The positions of the first and second reflectors may be detected, for example, by calculating the centroids of the reflectors from the optical data. As another example, the positions of the first and/or second reflectors may be identified by manually measuring the position(s) of the first and/or second reflectors.

The method 200 can include filtering data at 214. For example, the processing unit 110 can filter out data points having reflectivity or signal values below a predetermined threshold. This can make the method 200 and system 100 robust to dust in the environment. For example, the method 200 can disregard weak or low-quality signals that may result from environmental factors such as dust, fog, or other airborne particulates that can scatter or attenuate light signals. By applying this filtering mechanism, the method 200 ensures that only stronger, more reliable data points are used for tasks such as terrain mapping, obstacle detection, and tracking of moveable parts. For example, the reflectivity values of the data points may vary between a lower or minimum value and an upper or maximum value. The predetermined threshold used to filter out data points having lower reflectivity values may be 50% of the upper or maximum value, 60% of the upper or maximum value, or another percentage. This allows the method 200 to maintain accurate and consistent performance even in harsh or dusty environments commonly encountered on construction sites. The filtering process reduces noise in the data, improving the overall reliability and precision of the method 200.

As another example, the processing unit 110 (at 214) can use one or more than one box filter to filter out data points that are not associated with the reflectors (given the known positions of the reflectors in relation to the known position of the front antenna 145, which serves as a system reference point). The box filter can be a spatial filter that applies a uniform averaging operation over a defined region, or box, of data points. The processing unit 110 defines a rectangular or cubic region around a target data point in a dataset, such as a 3D point cloud, received from the optical sensor(s) 120, 130.

An operation such as averaging or summing is applied to these data points within the box to calculate an output value for the target point (e.g., the reflector in the point cloud). The size of the box (e.g., the width, height, and depth of the box) determines the range of data points included in the operation. The size of the box can be adjusted based on the specific requirements of the application, such as the density of the point cloud or the level of noise in the environment. The box filter smooths the point cloud data by averaging the values of points within the defined box. This helps to reduce random noise caused by environmental factors such as dust, debris, or sensor inaccuracies. The filter can exclude outlier points that deviate significantly from the surrounding data. For example, points with unusually high or low reflectivity values may be removed to improve the accuracy of terrain mapping and obstacle detection.

By aggregating data within the box, the filter reduces the overall complexity of the optical data (e.g., the point cloud). The box filter can be used by the processing unit 110 to isolate and enhance data points associated with reflectors placed on moveable parts of the asset. By focusing on points within a specific region, the processing unit 110 can more accurately track the position and orientation of arm and/or attachment of the asset.

In some examples, the processing unit 110 (at 214) compares the number of filtered data points to a number of points expected to be returned by each reflector to detect one or more than one error. For example, the processing unit 110 determines that the number of filtered data points (or the average or sum of the filtered data points) indicates an error when the number, average, or sum falls below a lower threshold. The errors that can be identified by the processing unit 110 in this way can be an object blocking the view between the optical sensor 120, 130 and the reflector, the reflector falling off the asset, damage to the reflector, a dirty optical sensor 120, 130, too much dust in the environment, a foreign reflective object close to the reflector, etc. If an error is detected, the processing unit 110 can return an error message so that the operator can identify and correct the error. In one example, the processing unit 110 may prevent continued movement of the asset, the arm, and/or the attachment responsive to such an error being identified.

c. Terrain Mapping

At 216, the optical data is analyzed to detect terrain elevation around the asset and/or generate or update a terrain map showing obstacles near the asset. The processing unit 110 analyzes the point cloud data from 208 (and which may be filtered) to detect the elevation of the terrain surrounding the asset, as well as generate a terrain map that may include the presence of any obstacles near the asset.

The processing unit 110 (at 216) can segment the point cloud to separate or differentiate terrain points from non-terrain objects, such as vehicles, trees, or buildings. These operations can be performed using algorithms that classify points based on height, reflectivity, and/or clustering. For example, the processing unit 110 differentiates between obstacles and terrain features by analyzing the point cloud data generated by the optical sensors 120, 130, along with data from other sensors like the location sensors and the movement sensor 160. The processing unit 110 differentiates between obstacles and terrain features using segmentation, classification, and filtering techniques. The point cloud data represents the surrounding environment, including both terrain features (e.g., ground, slopes) and obstacles (e.g., rocks, equipment, personnel). The location data from the location sensors and the movement data from the movement sensor 160 indicate the position and orientation of the asset, which is used by the processing unit 110 to identify the relative location of detected objects.

The processing unit 110 (at 216) can preprocess the point cloud data by applying noise filter(s) and/or outlier removal (e.g., using box filters). The processing unit 110 segments the point cloud into distinct clusters or regions to isolate potential obstacles from the terrain. The processing unit 110 can use progressive morphological filtering or cloth simulation filtering to identify ground points, or points in the data cloud indicative of the terrain. This can involve the processing unit 110 analyzing the relative height of points and their spatial distribution to distinguish ground points (e.g., terrain) from elevated objects. The non-ground points are grouped into clusters by the processing unit 110 based on the spatial proximity of the points using clustering algorithms (e.g., density-based spatial clustering of applications with noise) or k-means. Each cluster can represent a potential obstacle or terrain feature.

For each cluster, the processing unit 110 (at 216) extracts features to help classify the cluster as an obstacle or a terrain feature. These extracted features can include the height of the cluster of data points above the ground. The processing unit 110 can identify objects that are significantly elevated above the ground as obstacles (e.g., data point clusters that are at least a threshold height above the ground). The processing unit 110 can examine the dimensions (e.g., width, height, and/or depth) and shape of the clusters to differentiate between obstacles and terrain. For example, small, irregularly shaped clusters may be identified by the processing unit 110 as obstacles (e.g., rocks or debris), while larger, flatter clusters may represent terrain features (e.g., slopes or embankments). The processing unit 110 can examine reflectivity values of the data points in the cluster. The data points having greater reflectivity may be identified as metallic objects (e.g., obstacles such as other equipment), while lower reflectivity data points may be identified as the terrain. The processing unit 110 can examine the data points in the clusters to determine whether the cluster(s) is or are moving. If a cluster is detected by the processing unit 110 to be moving (e.g., using temporal data from consecutive LiDAR scans), the processing unit 110 can identify that cluster as being an obstacle (e.g., a person, animal, or vehicle).

The processing unit 110 (at 216) can classify each cluster as either an obstacle or a terrain feature using machine learning and/or rule-based algorithms. The processing unit 110 can compare the data and values to predefined thresholds for this classification. For example, predefined thresholds for features like height, size, and reflectivity are used to classify clusters. Clusters having a height above a certain threshold (e.g., 0.5 meters) are classified as obstacles, while clusters with large, flat shapes are classified as terrain features. The processing unit 110 can use supervised learning models (e.g., decision trees, support vector machines, or neural networks) trained on labeled datasets to classify clusters based on extracted features. These models can learn complex patterns and improve classification accuracy over time.

The processing unit 110 (at 216) can use temporal data from consecutive LiDAR scans to refine the classification of clusters. Static objects (e.g., rocks, terrain features) have data points that remain in the same or substantially same location across multiple scans. Conversely, dynamic objects (e.g., personnel, vehicles) may have data points that change position over time and are classified as obstacles. The processing unit 110 can compare a current point cloud with previous scans to detect newly introduced objects, which may be identified as obstacles.

The processing unit 110 (at 216) can integrate or fuse data from other sensors to improve the cluster classification. For example, the processing unit 110 can use the movement data from the movement sensor 160 to account for the roll, pitch, and/or yaw of the asset. This helps the processing unit 110 correctly identify terrain features even while the asset is on uneven ground. The processing unit 110 can use GNSS location information to differentiate between stationary obstacles and terrain features in the context of the location of the asset.

The processing unit 110 (at 216) can repeatedly update the classification of clusters as new point cloud data is collected. For example, the processing unit 110 can dynamically change the classification of an object from a terrain feature to an obstacle responsive to the cluster starting to move in successive scans.

The processing unit 110 (at 216) can generate the terrain map by converting the processed point cloud data into a structured representation. The processing unit 110 divides the terrain into a grid of cells (e.g., a 2D raster grid). For each cell, the processing unit 110 calculates an average, minimum, or maximum elevation of the data points within each cell. If no points exist in a cell, interpolation methods (e.g., nearest neighbor or bilinear interpolation) can be used by the processing unit 110 to estimate the elevation for that cell. The terrain map may be smoothed using techniques such as Gaussian filtering to reduce abrupt changes and create a more realistic representation. The terrain map can be integrated into the machine guidance system 100 to assist with path planning, grade control, and obstacle avoidance.

The processing unit 110 (at 216) can repeatedly update the terrain map as new point cloud data is collected. For example, as the asset moves, new point cloud data is merged with the existing terrain map to provide real-time updates. The processing unit 110 can detect changes in the terrain (e.g., newly excavated areas or obstacles) by comparing the updated point cloud with the existing map.

The processing unit 110 (at 216) generates the terrain map as a three-dimensional terrain map in real-time (e.g., the terrain map is generated or updated as the data is collected without introducing additional delays outside of normal computer processing). This terrain map can be created using data from optical sensors 120, 130, location data from the location sensors, and movement data from the movement sensor 160. The processing unit 110 differentiates obstacles from terrain features using these data sources.

d. Position and Orientation Calculation

At 218, the location data from the location sensors and the movement data from the movement sensor 160 is analyzed to determine the real-world position and orientation of the asset. The processing unit 110 can analyze the GNSS data from 212 and the IMU data from 210 to determine the geographic position and orientation (or heading) of the asset in a coordinate frame, such as the north-east-down (NED) coordinate frame. At 220, the processing unit 110 analyzes the terrain data from 216 and the movement data from 210 to map the terrain surrounding the asset (including any detected obstacles) in the NED coordinate frame or another coordinate system.

At 222, the reflector data from 214 is analyzed along with known dimensions of the asset to determine the position and orientation of the arm of the asset and/or of the attachment, such as the cutting edge of the bucket attachment. The processing unit 110 can determine the positions and orientations using models that mathematically describe the asset configuration through the use of forward kinematics.

At 224, the position and orientation of the asset from 218 and the position and orientation of the attachment (e.g., the cutting edge of the bucket attachment) from 222 are examined to calculate the elevation of the attachment (e.g., the cutting edge of the bucket attachment).

For example, the processing unit 110 (at 224) can determine the elevation of the cutting edge of the bucket by combining the position and orientation of the loader (from 218) with the position and orientation of the cutting edge of the bucket attachment (from 222). The processing unit 110 can apply geometric transformations and kinematic relationships to map the relative position of the cutting edge to the coordinate system (e.g., the global coordinate system). The position and orientation of the asset (e.g., in X, Y, and Z coordinates) is determined using location data and movement data. The orientation of the asset (e.g., roll, pitch, and yaw) also is provided by the movement data and the location data. The relative position of the cutting edge of the bucket with respect to the asset is determined using data from the optical sensors 120, 130 and the known relative position of the reflector on the bucket to the cutting edge of the bucket. For example, the orientation of the cutting edge (e.g., tilt angle) can be calculated or derived from the geometry of the bucket. To determine the elevation of the cutting edge, the processing unit 110 can define the position and orientation of the asset in a coordinate system (e.g., a local coordinate system). The position and orientation of the cutting edge of the bucket are calculated relative to this local coordinate system. The processing unit 110 uses the position and orientation of the asset to transform the relative position of the cutting edge to the asset into the global coordinate system.

At 226, the elevation of the terrain can be determined from the position and orientation of the terrain from 220. The processing unit 110 can determine the terrain elevation using the position and orientation of the terrain derived in 220. The processing unit 110 examines the point cloud data generated by the optical sensors 120, 130 to calculate the elevation of the terrain at specific locations. This information may be used to display or otherwise provide the current state of the asset via a user interface—for example, either as raw values or in relation to a three-dimensional site plan.

e. Operation without Reliance on GNSS

While the location sensors may include GNSS antennas 145, 155 and receivers 140, 150, in some embodiments, the machine guidance system 100 does not include the antennas 145, 155 or receivers 140, 150, or can operate while the location sensors are inoperable or do not have access to satellite signals. For example, the machine guidance system 100 can operate indoors or in subterranean areas without having access to GNSS (e.g., GPS) signals.

In such a situation, reflectors (e.g., passive reflectors) can be placed in known locations off-board the asset. For example, the reflectors can be placed on walls or structures as reference points for positioning. The optical sensors 120, 130 and processing unit 110 can detect these off-board reflectors using point cloud data similar to how the optical sensors 120, 130 and processing unit 110 detect the reflectors onboard the asset. The size and/or shape of these off-board reflectors as detected by the processing unit 110 can indicate the location of the asset to the processing unit 110. For example, if square-shaped reflectors are used, the processing unit 110 can examine the point cloud data to determine whether the reflectors appear to have a square shape, a rectangular shape, a diamond shape, or the like. These different detected shapes (as well as the detected sizes) of the off-board reflectors can indicate how far (e.g., based on detected size) and the relative location of (e.g., based on the detected shape) the asset (or the optical sensor 120 and/or 130) relative to the off-board reflector. This feature allows the machine guidance system 100 to function in environments where GNSS satellite signals are unavailable, such as underground construction sites, mines, warehouses, etc.

### III. Example Asset

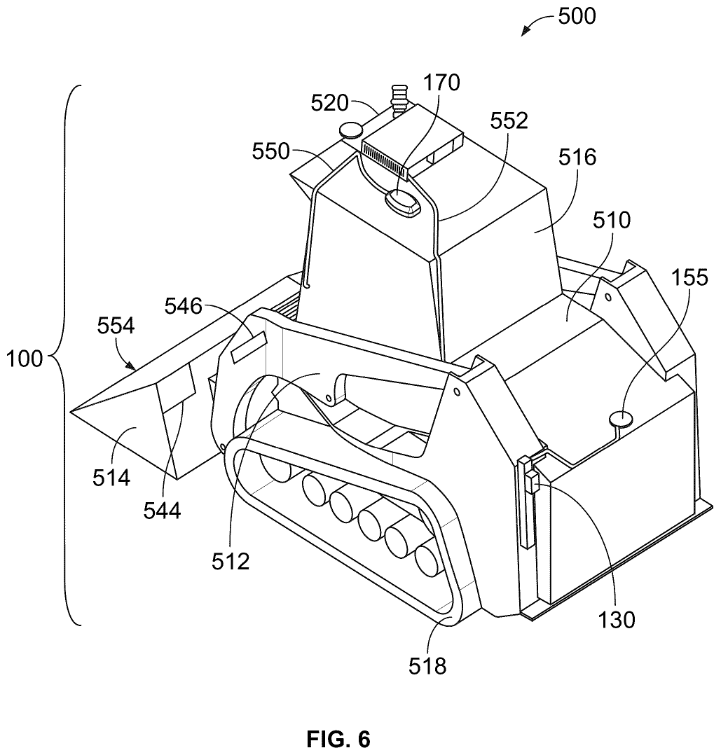

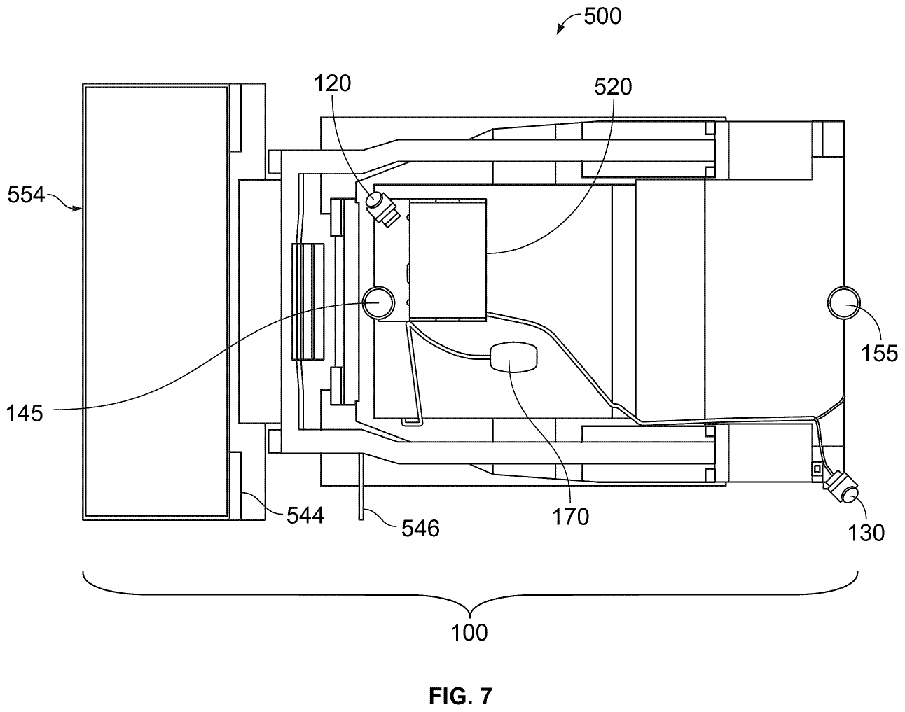

FIG. 6 is a perspective view of one example of the machine guidance system 100 shown in FIG. 1 onboard an asset 500. FIG. 7 is a top plan view of the machine guidance system 100 and the asset 500 shown in FIG. 6. The asset 500 is illustrated as a track loader that may be manually, semi-autonomously, and/or autonomously operated using the machine guidance system 100 described above. It should be understood that this example embodiment is provided to describe the various capabilities of the machine guidance system 100 and not to limit all embodiments of the inventive subject matter described herein.

The asset 500 includes a main body 510 connected to a lift arm 512, which is in turn connected to a bucket attachment 514. Other types of attachments may be attached to the lift arm 512, such as a tooth bucket, a mower, a dozer blade, a soil conditioner, a grapple, a trencher, or the like. The asset 500 also includes a cab 516 that provides an enclosure from which the operator can operate the asset 500. The asset 500 further includes a track 518 that enables movement of the asset 500 across rugged terrain. In some embodiments, the asset 500 may include wheels to move.

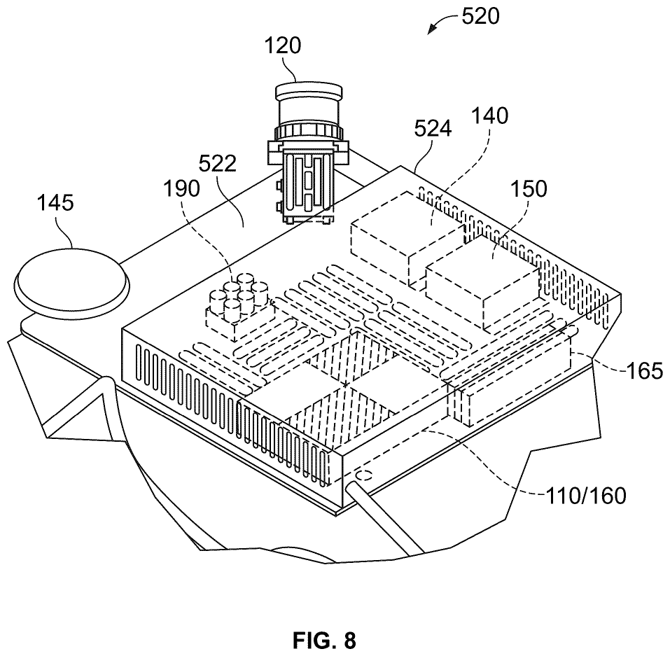

With continued reference to the asset 500 and the machine guidance system 100 shown in FIGS. 6 and 7, FIG. 8 illustrates a perspective view of a machine guidance assembly 520. The machine guidance system 100 of the asset 500 includes a machine guidance assembly 520 rigidly mounted on top of the cab 516. In some embodiments, the machine guidance assembly 520 may be mounted or located elsewhere on or in the asset 500. The machine guidance assembly 520 includes a rigid plate 522 on which is mounted a ruggedized enclosure 524 that provides isolated interfaces to the processing unit 110 and movement sensor 160, the communication network device 165, the front GNSS receiver 140, the rear GNSS receiver 150, and a power splitter 190. The cover of the ruggedized enclosure 524 is removed in FIG. 8 to show these components.

Also mounted to the rigid plate 522 is the front GNSS antenna 145 and the front optical sensor 120. In this example, the front GNSS antenna 145 is mounted on the rigid plate 522 at a location that is as far forward as possible along the x-axis of the asset 500 and generally centered along the y-axis of the asset 500. The front optical sensor 120 can be mounted on the rigid plate 522 at a location that allows the door of the cab 516, if so configured with a door, to be opened and closed, avoids contact with the arm 512 as the arm 512 is raised and lowered, and provides a line of sight to the arm/attachment joint when the arm 512 is lowered.

As shown in FIGS. 6 and 7, the asset 500 includes the rear GNSS antenna 155 mounted at the rear of the main body 510. The rear antenna 155 can be centrally located at the rear of the main body 510 to be oriented in a straight-line with the front antenna 145 along the x-axis of the asset 500. In some embodiments, the locations of the front and rear antennas 145, 155 could both be shifted along the y-axis of the asset 500 so long as the straight-line orientation between the antennas 145, 155 is maintained. In some embodiments, the location of the rear antenna 155 could be offset with respect to the front antenna 145 along the y-axis of the asset 500 as long as the location of the rear antenna 155 can be calibrated based on data from the optical sensor 120 and/or the optical sensor 130.

The machine guidance system 100 onboard the asset 500 also includes the rear optical sensor 130 mounted at or toward the rear of the main body 510. The rear optical sensor 130 can be located on the left side of the rear of the main body 510 to provide a line of sight to a first attachment reflector 544 placed on the left side of the bucket attachment 514 and a second arm reflector 546 placed on the left side of the lift arm 512 of the asset 500. The reflectors 544, 546 may be onboard the asset 500 in that the reflectors 544, 546 are mounted to the asset 500 or the attachment 514 that is coupled with the asset 500. The onboard reflectors 544, 546 may be passive reflectors as described above. The reflectors 544, 546 can be positioned to be within the field of view of the front optical sensor 120 such that one or more than one line of sight exists between the front optical sensor 120 and each of the reflectors 544, 546, or at least one of the reflectors 544, 546. In some embodiments, the front and rear optical sensors 120, 130 track movement and/or positions of the lift arm 512 and bucket attachment 514 throughout their entire range of movement, and can be positioned to provide a 360-degree field of view around the asset 500.

The asset 500 further includes the 5G/LTE/WiFi antenna 170 mounted at a fixed location on top of the cab 516. The asset 500 includes a first harness 550 that connects the machine guidance assembly 520 to the power adapter 195 and computing device located within the cab 516, as well as a second harness 552 that connects the machine guidance assembly 520 to the rear antenna 155 and rear optical sensor 130. In some embodiments, all of the components of the machine guidance assembly 520, the front antenna 145, the front optical sensor 120, the rear antenna 155, and the rear optical sensor 130 are rigidly attached to the asset 500 so that the deflections are less than 0.1 millimeters with 5G shock and vibration. Also, the asset 500 also includes the ACU 180 and various components located within the cab 516, including the onboard computing device 175, the input device 182, output devices 184, 186, and the power adapter 195.

One or more examples of machine guidance system described herein can include a sensor suite configured to be mounted on a construction vehicle. The sensor suite can include an optical sensor configured to emit light pulses and to receive reflected light. The optical sensor can generate point cloud data from a field of view that includes a moveable part of the construction vehicle bearing a reflector. The sensor suite also can include a location sensor configured to obtain satellite signals and output location data indicative of a geographic location of the construction vehicle, and a movement sensor configured to generate movement data indicative of at least one of acceleration, angular velocity, and/or orientation of the construction vehicle. The machine guidance system can include a processing unit electrically coupled to the sensor suite. The processing unit can be configured to fuse the point cloud data, the location data, and the movement data. The processing unit can calculate a position and orientation of the moveable part of the construction vehicle, identify an obstacle outside of the construction vehicle, and generate a terrain map using the point cloud data, the location data, and the movement data that is fused.

The processing unit can change or stop movement of the construction vehicle or the moveable part, or direct an asset control unit to change or stop the movement of the construction vehicle or the moveable part, based on one or more of the position and orientation of the moveable part that is determined, the obstacle that is identified, or the terrain map. The optical sensor can be or can include a light detection and ranging (LiDAR) sensor. The LiDAR sensor can be a front LiDAR sensor mounted closer to a front of the construction vehicle than a rear of the construction vehicle, and the sensor suite also can include a rear LiDAR sensor mounted closer to the rear of the construction vehicle than the front of the construction vehicle. The rear LiDAR sensor can generate the point cloud data for the processing unit to fuse with the location data and the movement data. The machine guidance system can include the reflector that is a passive reflector.

The location sensor can be or can include a global navigation satellite system (GNSS) receiver. The movement sensor can be or can include an inertial measurement unit (IMU) sensor configured to generate movement data indicative of one or more of roll, pitch, or yaw of the construction vehicle. The moveable part can include one or more of a lift arm, a bucket attachment, a mower attachment, a blade, a soil conditioner, or an excavator bucket.

The processing unit can generate the terrain map by segmenting the point cloud data into terrain features, and the processing unit can generate the terrain map by distinguishing the terrain features from the obstacle that also is identified. The processing unit can control the movement of the construction vehicle by adjusting a speed or a trajectory of the construction vehicle based on the position and the orientation of the moveable part that is calculated, the obstacle that is identified, or the terrain map that is generated.

One or more examples of a method or process described herein include generating point cloud data using an optical sensor. The point cloud data can be generated from a field of view of the optical sensor in which light pulses are emitted and reflected light is received. The field of view of the optical sensor can include a moveable part of a construction vehicle bearing a reflector. The method also can include obtaining location data indicative of a geographic location of the construction vehicle. The location data can be obtained from a location sensor that received satellite signals to output the location data. The method also can include generating movement data using a movement sensor. The movement data can indicate of at least one of acceleration, angular velocity, or orientation of the construction vehicle. The method also can include fusing the point cloud data, the location data, and the movement data, calculating a position and orientation of the moveable part of the construction vehicle using the point cloud data, the location data, and the movement data that is fused, identifying an obstacle outside of the construction vehicle using the point cloud data, the location data, and the movement data that is fused, and generating a terrain map using the point cloud data, the location data, and the movement data that is fused.

The method also can include changing or stopping movement of the construction vehicle or the moveable part based on one or more of the position and orientation of the moveable part that is determined, the obstacle that is identified, or the terrain map. The point cloud data can be generated by a front LiDAR sensor mounted closer to a front of the construction vehicle than a rear of the construction vehicle, the point cloud data also generated by a rear LiDAR sensor mounted closer to the rear of the construction vehicle than the front of the construction vehicle. The point cloud data can be generated by reflection of at least some of the light pulses off the reflector that is a passive reflector.

The location data can be received from a global navigation satellite system (GNSS) receiver. The movement data can be received from an inertial measurement unit (IMU) sensor and indicates one or more of roll, pitch, or yaw of the construction vehicle. The terrain map can be generated by segmenting the point cloud data into terrain features, and distinguishing the terrain features from the obstacle that also is identified.

The method also can include controlling the movement of the construction vehicle by adjusting a speed or a trajectory of the construction vehicle based on the position and the orientation of the moveable part that is calculated, the obstacle that is identified, or the terrain map that is generated.

One or more examples described herein provide a machine guidance system that can include optical sensors including a front light detection and ranging (LiDAR) sensor mounted toward a front of a construction vehicle and a rear LiDAR sensor mounted toward a rear of the construction vehicle. Each of the optical sensors can emit light pulses, receive reflected light, and generate point cloud data from fields of view of the optical sensors that include a moveable part of the construction vehicle bearing a passive reflector. The machine guidance system can include location sensors including a front global navigation satellite system (GNSS) receiver and a rear GNSS receiver. The location sensors can obtain satellite signals from front and rear GNSS antennas, respectively, at least one of the location sensors providing a reference location and another of the location sensors outputting a second location, the reference location and the second location indicative of a heading and a pitch of the construction vehicle. The machine guidance system can include an inertial measurement unit (IMU) sensor configured to generate movement data indicative of at least one of acceleration, angular velocity, or orientation of the construction vehicle, and a processing unit coupled to the optical sensors, the location sensors, and the IMU sensor. The processing unit can fuse the point cloud data, the reference location, the second location, and the movement data, calculate a position and orientation of the moveable part of the construction vehicle, identify an obstacle outside of the construction vehicle, and generate a terrain map using the point cloud data, the reference location, the second location, and the movement data that is fused.

The processing unit can control the movement of the construction vehicle or directing an asset control unit to control the movement of the construction vehicle by adjusting a speed or a trajectory of the construction vehicle based on the position and the orientation of the moveable part that is calculated, the obstacle that is identified, or the terrain map that is generated.

References to “one embodiment,” “an embodiment,” “an example embodiment,” or “embodiments” mean that the feature or features being described are included in at least one embodiment of a machine guidance system deployed on a construction vehicle. Separate references to “one embodiment,” an embodiment, “an example embodiment,” or “embodiments” in this disclosure do not necessarily refer to the same embodiment and are also not mutually exclusive unless so stated and/or except as will be readily apparent to one of ordinary skill in the art from the disclosure. For example, a feature, structure, function, etc. described in one embodiment may also be included in other embodiments, but is not necessarily included. Thus, a machine guidance system or method can include a variety of combinations and/or integrations of the features, structures, functions, etc. described herein.

The embodiments described herein are provided for illustrative purposes and are not intended to limit the scope of the described subject matter. Certain details, well-known to those skilled in the art, may be omitted for clarity and brevity. The described subject matter includes various modifications, rearrangements, and substitutions of components or processes, provided they fall within the scope of the claims. Accordingly, the specific examples and configurations described herein are not to be construed as limiting, but rather as representative of the broader concepts presented.

In this disclosure, the use of any and all examples or exemplary language (such as “for example”) is intended merely to better describe the embodiments and does not pose a limitation on the scope of all embodiments of the inventive subject matter. No language in the disclosure should be construed as indicating any non-claimed element essential to the practice of the inventive subject matter.

Also, the use of the terms “comprises,” “comprising,” or any other variation thereof, are intended to cover a non-exclusive inclusion, such that a system, device, or method that comprises a list of elements does not include only those elements, but may include other elements not expressly listed or inherent to such system, device, or method.

Further, the use of relative relational terms, such as first and second, are used solely to distinguish one unit or action from another unit or action without necessarily requiring or implying any actual such relationship or order between such units or actions.

Finally, while the inventive subject matter has been described and illustrated hereinabove with reference to various example embodiments, it should be understood that various modifications could be made to these embodiments without departing from the scope of the invention. Therefore, the inventive subject matter is not to be limited to the specific structural configurations or methodologies of the example embodiments, except insofar as such limitations are included in the following claims.

What is claimed is:

1. A machine guidance system comprising:
a sensor suite configured to be mounted on a construction vehicle, the sensor suite including:
an optical sensor configured to emit light pulses and to receive reflected light, the optical sensor generating point cloud data from a field of view that includes a moveable part of the construction vehicle bearing a reflector;
a location sensor configured to obtain satellite signals and output location data indicative of a geographic location of the construction vehicle; and
a movement sensor configured to generate movement data indicative of at least one of acceleration, angular velocity, or orientation of the construction vehicle; and
a processing unit electrically coupled to the sensor suite, the processing unit configured to fuse the point cloud data, the location data, and the movement data, the processing unit configured to calculate a position and orientation of the moveable part of the construction vehicle, identify an obstacle outside of the construction vehicle, and generate a terrain map using the point cloud data, the location data, and the movement data that is fused.

2. The machine guidance system of claim 1, wherein the processing unit is configured to change or stop movement of the construction vehicle or the moveable part, or direct an asset control unit to change or stop the movement of the construction vehicle or the moveable part, based on one or more of the position and orientation of the moveable part that is determined, the obstacle that is identified, or the terrain map.

3. The machine guidance system of claim 1, wherein the optical sensor is a light detection and ranging (LiDAR) sensor.

4. The machine guidance system of claim 3, wherein the LiDAR sensor is a front LiDAR sensor mounted closer to a front of the construction vehicle than a rear of the construction vehicle, and further comprising:
a rear LiDAR sensor mounted closer to the rear of the construction vehicle than the front of the construction vehicle, the rear LiDAR sensor also configured to generate the point cloud data for the processing unit to fuse with the location data and the movement data.

5. The machine guidance system of claim 1, further comprising the reflector, wherein the reflector is a passive reflector.

6. The machine guidance system of claim 1, wherein the location sensor includes a global navigation satellite system (GNSS) receiver.

7. The machine guidance system of claim 1, wherein the movement sensor is an inertial measurement unit (IMU) sensor configured to generate movement data indicative of one or more of roll, pitch, or yaw of the construction vehicle.

8. The machine guidance system of claim 1, wherein the moveable part comprises one or more of a lift arm, a bucket attachment, a mower attachment, a blade, a soil conditioner, or an excavator bucket.

9. The machine guidance system of claim 1, wherein the processing unit is configured to generate the terrain map by segmenting the point cloud data into terrain features, and wherein the processing unit is configured to generate the terrain map by distinguishing the terrain features from the obstacle that also is identified.

10. The machine guidance system of claim 1, wherein the processing unit is further configured to control the movement of the construction vehicle by adjusting a speed or a trajectory of the construction vehicle based on the position and the orientation of the moveable part that is calculated, the obstacle that is identified, or the terrain map that is generated.

11. A method comprising:
generating point cloud data using an optical sensor, the point cloud data generated from a field of view of the optical sensor in which light pulses are emitted and reflected light is received, the field of view of the optical sensor including a moveable part of a construction vehicle bearing a reflector;
obtaining location data indicative of a geographic location of the construction vehicle, the location data obtained from a location sensor that received satellite signals to output the location data;
generating movement data using a movement sensor, the movement data indicative of at least one of acceleration, angular velocity, or orientation of the construction vehicle;
fusing the point cloud data, the location data, and the movement data;
calculating a position and orientation of the moveable part of the construction vehicle using the point cloud data, the location data, and the movement data that is fused;
identifying an obstacle outside of the construction vehicle using the point cloud data, the location data, and the movement data that is fused; and
generating a terrain map using the point cloud data, the location data, and the movement data that is fused.

12. The method of claim 11, further comprising:
changing or stopping movement of the construction vehicle or the moveable part based on one or more of the position and orientation of the moveable part that is determined, the obstacle that is identified, or the terrain map.

13. The method of claim 11, wherein the point cloud data is generated by a front LiDAR sensor mounted closer to a front of the construction vehicle than a rear of the construction vehicle, the point cloud data also generated by a rear LiDAR sensor mounted closer to the rear of the construction vehicle than the front of the construction vehicle.

14. The method of claim 11, wherein the point cloud data is generated by reflection of at least some of the light pulses off the reflector that is a passive reflector.

15. The method of claim 11, wherein the location data is received from a global navigation satellite system (GNSS) receiver.

16. The method of claim 11, wherein the movement data is received from an inertial measurement unit (IMU) sensor and indicates one or more of roll, pitch, or yaw of the construction vehicle.

17. The method of claim 11, wherein the terrain map is generated by:
segmenting the point cloud data into terrain features; and
distinguishing the terrain features from the obstacle that also is identified.

18. The method of claim 11, further comprising controlling the movement of the construction vehicle by adjusting a speed or a trajectory of the construction vehicle based on the position and the orientation of the moveable part that is calculated, the obstacle that is identified, or the terrain map that is generated.

19. A machine guidance system comprising:
optical sensors including a front light detection and ranging (LiDAR) sensor mounted toward a front of a construction vehicle and a rear LiDAR sensor mounted toward a rear of the construction vehicle, each of the optical sensors configured to emit light pulses, receive reflected light, and generate point cloud data from fields of view of the optical sensors that include a moveable part of the construction vehicle bearing a passive reflector;
location sensors including a front global navigation satellite system (GNSS) receiver and a rear GNSS receiver, the location sensors configured to obtain satellite signals from front and rear GNSS antennas, respectively, at least one of the location sensors providing a reference location and another of the location sensors outputting a second location, the reference location and the second location indicative of a heading and a pitch of the construction vehicle;
an inertial measurement unit (IMU) sensor configured to generate movement data indicative of at least one of acceleration, angular velocity, or orientation of the construction vehicle; and
a processing unit coupled to the optical sensors, the location sensors, and the IMU sensor, the processing unit configured to fuse the point cloud data, the reference location, the second location, and the movement data, the processing unit configured to calculate a position and orientation of the moveable part of the construction vehicle, identify an obstacle outside of the construction vehicle, and generate a terrain map using the point cloud data, the reference location, the second location, and the movement data that is fused.

20. The machine guidance system of claim 19, wherein the processing unit is configured to control the movement of the construction vehicle or directing an asset control unit to control the movement of the construction vehicle by adjusting a speed or a trajectory of the construction vehicle based on the position and the orientation of the moveable part that is calculated, the obstacle that is identified, or the terrain map that is generated.
